(19) United States
(12) Patent Application Publication
(10) Pub. No.: US 2019/0138151 A1
(43) Pub. Date: May 9, 2019

(54) METHOD AND SYSTEM FOR CLASSIFYING TAP EVENTS ON TOUCH PANEL, AND TOUCH PANEL PRODUCT

(71) Applicant: Silicon Integrated Systems Corp., Hsinchu City (TW)

(72) Inventors: Tsung-Hua Tsai, Hsinchu City (TW); Jing-Jyh Yeh, Hsinchu City (TW)

(21) Appl. No.: 16/179,095

(22) Filed: Nov. 2, 2018

(30) Foreign Application Priority Data
Nov. 3, 2017 (TW) 106138197

(51) Int. Cl. G06F 3/041; G06F 3/0488; G06N 3/08

(52) U.S. Cl. CPC G06F 3/0418; G06N 3/084; G06F 3/04883

(57) ABSTRACT

A method for classifying tap events on a touch panel includes collecting the tap events on the touch panel and recording the type of each of the tap events as a sample; generating a sample set including a plurality of the samples; using the sample set to train a deep neural network to determine an optimized weighting parameter group; taking the deep neural network and the optimized weighting parameter group as a tapping classifier and deploying it in a touch panel product. The present disclosure also provides a system corresponding to the classifying method, and a touch panel product.

### BACKGROUND

### 1. Field of Disclosure

The present disclosure relates to sensing technologies, and more particularly to a method and system for classifying tap events on touch panel, and a touch panel product.

### 2. Description of Related Art

Existing large-sized touch display devices are equipped with marking and drawing software for users to mark on display screens to illustrate the content shown on the screens. The marking and drawing software usually has a main menu displayed on an edge of the screen. By way of the main menu, the users can adjust a brush color or a brush size. However, the size of the screen is quite large. The main menu may be distanced away from a user. It is very inconvenient for the user to click on the main menu. It is pretty troubling for the user to adjust brush properties.

Therefore, there is a need to provide a new solution to solve above problems.

### SUMMARY

An objective of the present disclosure is to provide a method and system for classifying tap events on a touch panel and a touch panel product, for improving accuracy of predictions on tap types.

To achieve above objective, an aspect of the present disclosure provides a method for classifying tap events on a touch panel, including: using a vibration sensor to detect various tap events on the touch panel to obtain a plurality of measured vibration signals; sampling each of the vibration signals and obtaining a plurality of feature values for each vibration signal; taking the feature values of one vibration signal and a classification label recorded based on a type of the tap event corresponding to the one vibration signal as a sample and generating a sample set including a plurality of samples; taking the feature values of one sample as an input and a freely-selected weighting parameter group as an adjusting parameter and inputting them into a deep neural network to obtain a predicted classification label; adjusting the weighting parameter group by way of a backpropagation algorithm based on an error lying between the predicted classification label and an actual classification label of the sample; and taking out the samples of the sample set in batches to train the deep neural network and fine tune the weighting parameter group to determine an optimized weighting parameter group.

Another aspect of the present disclosure provides a system for classifying tap events on a touch panel, including: a touch panel; a vibration sensor arranged with the touch panel, configured to detect various tap events on the touch panel to obtain a plurality of measured vibration signals; a processor coupled to the vibration sensor, configured to receive the vibration signals transmitted from the vibration sensor; and a memory connected to the processor, including a plurality of program instructions executable by the processor, the processor executing the program instructions to perform a method including: sampling each of the vibration signals and obtaining a plurality of feature values for each vibration signal; taking the feature values of one vibration signal and a classification label recorded based on a type of the tap event corresponding to the one vibration signal as a sample and generating a sample set including a plurality of samples; taking the feature values of one sample as an input and a freely-selected weighting parameter group as an adjusting parameter and inputting them into a deep neural network to obtain a predicted classification label; adjusting the weighting parameter group by way of a backpropagation algorithm based on an error lying between the predicted classification label and an actual classification label of the sample; and taking out the samples of the sample set in batches to train the deep neural network and fine tune the weighting parameter group to determine an optimized weighting parameter group.

Still another aspect of the present disclosure provides a touch panel product, including: a touch panel; a vibration sensor arranged with the touch panel, configured to detect a vibration signal generated by a tap operation performed to the touch panel; and a controller coupled to the vibration sensor, wherein a deep neural network corresponding to the deep neural network according to above method is deployed in the controller, and the controller is configured to take the corresponding deep neural network and the optimized weighting parameter group obtained according to above method as a model and input the vibration signal from the vibration sensor into the model to obtain a predicted tap type.

In the present disclosure, deep learning with the deep neural network is adopted to classify various tap events on the touch panel to obtain a prediction model. The prediction model is deployed in the touch display product. Accordingly, end products can predict types of tap motions made by users to obtain predicted tap types (e.g., how many time the tap motions are made), and carry out various applications for these tap types in software applications. The present disclosure can effectively improve accuracy of predictions on tap types by use of the deep learning and greatly improve applicability.

### BRIEF DESCRIPTION OF DRAWINGS

FIG. 1 is a schematic diagram illustrating a system for classifying tap events on a touch panel according to an embodiment of the present disclosure.

FIG. 2 is a flowchart of a method to train a tap classifier for classifying tap events on a touch panel according to an embodiment of the present disclosure.

FIG. 3 is a schematic diagram illustrating a vibration signal in a time distribution form according to an embodiment of the present disclosure.

FIG. 4 is a schematic diagram illustrating a vibration signal in frequency space according to an embodiment of the present disclosure.

FIG. 5 is a schematic diagram illustrating a deep neural network according to an embodiment of the present disclosure.

FIG. 6 is a schematic diagram illustrating a touch panel product according to an embodiment of the present disclosure.

FIG. 7 is a flowchart of a method to predict the type of tap events on a touch panel according to an embodiment of the present disclosure.

### DETAILED DESCRIPTION OF PREFERRED EMBODIMENTS

To make the objectives, technical schemes, and technical effects of the present disclosure more clearly and definitely, the present disclosure will be described in detail below by using embodiments in conjunction with the appending drawings. It should be understood that the specific embodiments described herein are merely for explaining the present disclosure, and as used herein, the term “embodiment” refers to an instance, an example, or an illustration but is not intended to limit the present disclosure. In addition, the articles “a” and “an” as used in the specification and the appended claims should generally be construed to mean “one or more” unless specified otherwise or clear from the context to be directed to a singular form.

In the present disclosure, deep learning is utilized to learn to classify tap events on a touch panel to obtain a classification model. By use of the classification model, tap motions made by users on products employing touch control technologies can be classified to yield tap types (e.g., how many times the tap motions are made), thereby performing predetermined operations corresponding to the tap types.

For example, the types of the tap events may include a one-time tap, a two-time tap, or a three-time tap using a pen or finger.

The predetermined operations may be configured based on different application scenarios. For example, for a large-sized touch panel, the one-time tap may correlate to an operation of opening or closing a menu, the two-time tap may correlate to an operation of changing a brush color, and the three-time tap may correlate to an operation of changing a brush size. As described below, a person skilled in the art can understood that the inventive concepts of the present disclosure can be applied to other aspects. Of course, relations between the number of time of taping and the operations to be performed can be defined by users themselves.

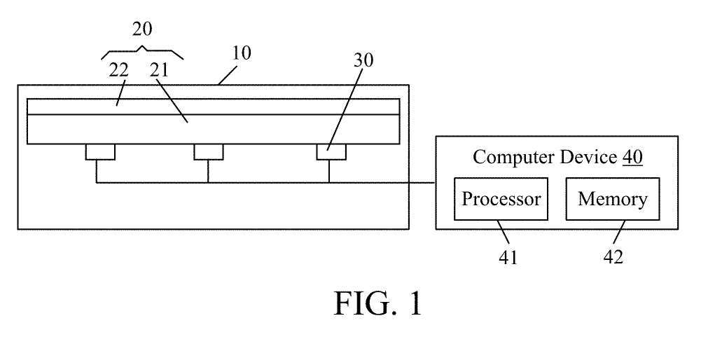

FIG. 1 is a schematic diagram illustrating a system for classifying tap events on a touch panel according to an embodiment of the present disclosure. The system includes a touch control device 10 and a computer device 40 coupled to the touch control device 10. The touch control device 10 can be a display device having a touch control function, and can display images by way of a display panel (not shown) and receive touch control operations made by users. The computer device 40 can be a computer having a certain degree of computing ability, such as a personal computer and a notebook computer. In the present disclosure, in order to classify the tap events, it first needs to collect the tap events. In this regard, taps on the touch control device 10 are manually made. Signals corresponding to the tap events are transmitted to the computer device 40. The computer device 40 proceeds with learning using a deep neural network.

The touch control device 10 includes a touch panel 20, which includes a signal transmitting (Tx) layer 21 and a signal receiving (Rx) layer 22 for detecting user touch operations. The touch control device 10 further includes a vibration sensor 30 such as an accelerometer. The vibration sensor 30 can be arranged at any position of the touch control device 10. Preferably, the vibration sensor 30 is disposed on a bottom surface of the touch panel 20. The vibration sensor 30 is configured to detect tap motions made to the touch control device 10 to generate corresponding vibration signals. In a situation that the vibration sensor 30 is disposed on the bottom surface of the touch panel 20, the taps on the touch panel 20 may generate better signals.

The computer device 40 receives the vibration signals generated by the vibration sensor 30, via a connection port, and feeds the signals into the deep neural network for classification learning. After the tap events are manually produced, the type of each of the tap events can be inputted to the computer device 40 for supervised learning. As shown in FIG. 1, the computer device 40 includes a processor 41 and a memory 42. The processor 41 is coupled to the vibration sensor 30. The processor 41 receives the vibration signals transmitted from the vibration sensor 30. The memory 42 is connected to the processor 41. The memory 42 includes a plurality of program instructions executable by the processor 41. The processor 41 executes the program instructions to perform calculations relating to the deep neural network. The computer device 40 may adopt GPU or TPU to perform the calculations relating to the deep neural network for improving computational speed.

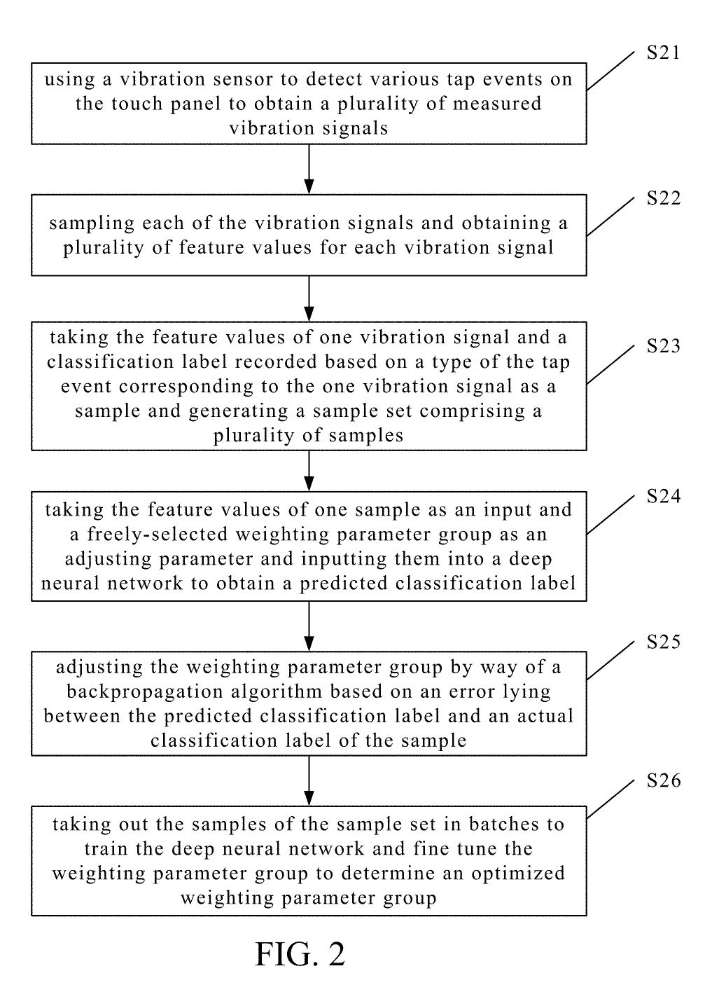

FIG. 2 is a flowchart of a method to train a tap classifier for classifying tap events on a touch panel according to an embodiment of the present disclosure. Referring to FIG. 2 with reference to FIG. 1, the method includes the following steps.

Step S21—using a vibration sensor 30 to detect various tap events on the touch panel 20 to obtain a plurality of measured vibration signals. In this step, various types of tap events on the touch panel 20 are manually produced. The vibration sensor 20 disposed on the bottom surface of the touch panel 20 generates vibration signals by detecting the tap events. In the present disclosure, the number of the vibration sensor 20 is not restricted to one entity. A plurality of the vibration sensors 20 may be deployed. The vibration sensor 20 can also be disposed at any position of the touch control device 10. The vibration sensor 20 can detect a tap motion made at any position of the surface of the touch control device 10. The detection is not limited to tap motions made on the touch panel 10.

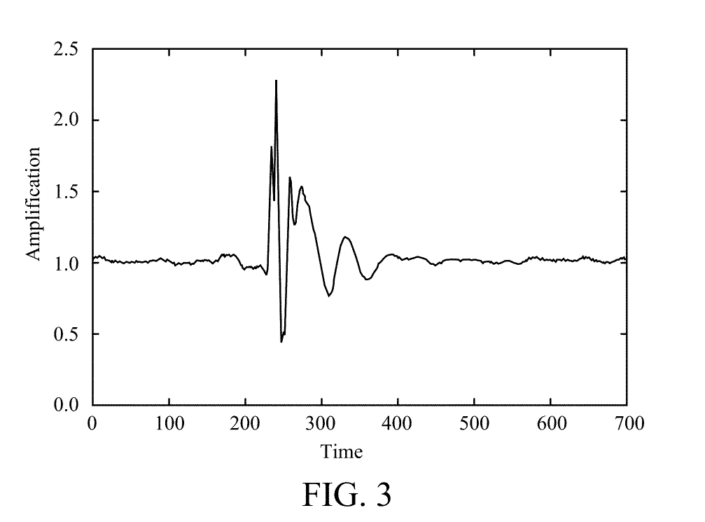

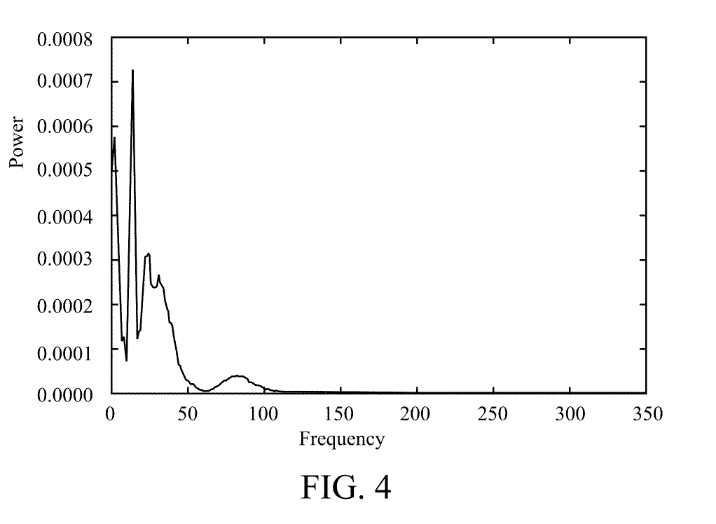

The acceleration measured by the vibration sensor 30 is a function of time and has three directional components. FIG. 3 illustrates time distribution of an acceleration signal corresponding to a certain tap event. In an embodiment, Fourier transform can be utilized to convert the three directional components to frequency space, as shown in FIG. 4. Specifically, the method may further include a step of converting each of the vibration signals from time distribution to frequency space.

After converting to the frequency space, low-frequency DC components and high-frequency noise signals may be further filtered and removed in order to prevent classification results from being affected by the gravitational acceleration and the noise signals. Specifically, the method may further include a step of filtering each of the vibration signals to remove portions of high frequencies and low frequencies.

Step S22—sampling each of the vibration signals and obtaining a plurality of feature values for each vibration signal. In this step, each of the vibration signals generated by the vibration sensor 30 is sampled. For example, a plurality of data points are obtained by sampling the vibration signal in the frequency space at certain frequency intervals. These data points are feature values, which serve as training data of the deep neural network after normalization.

Step S23—taking the feature values of one vibration signal and a classification label recorded based on a type of the tap event corresponding to the one vibration signal as a sample and generating a sample set including a plurality of samples. In this step, one vibration signal measured by the vibration sensor 30 and the type of a tap event corresponding to the one vibration signal serve as a record, that is, a sample. A sample set consists of a plurality of samples. Specifically, a sample includes the feature values of one vibration signal and a classification label corresponding to the one vibration signal.

The sample set can be divided into a training sample set and a test sample set. The training sample set can be used to train the deep neural network. The test sample set is used to test a trained deep neural network to yield accuracy of the classification.

Step S24—taking the feature values of one sample as an input and a freely-selected weighting parameter group as an adjusting parameter and inputting them into a deep neural network to obtain a predicted classification label. The feature values of one sample obtained from Step S23 is inputted to the deep neural network via an input layer. The deep neural network outputs a predicted classification label.

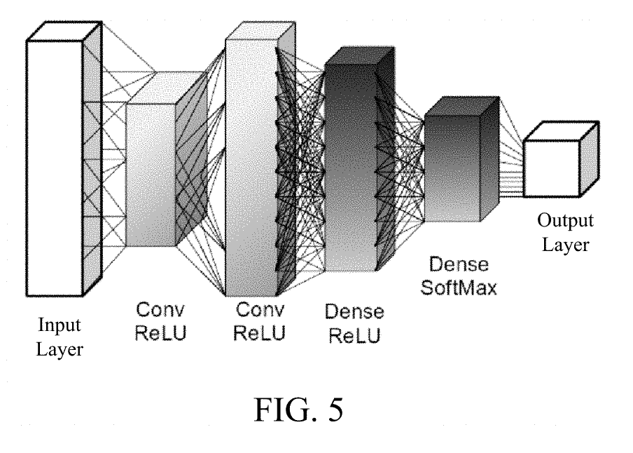

FIG. 5 illustrates an example of deep neural network. The deep neural network generally includes an input layer, an output layer, and learning layers between the input layer and the output layer. Each sample of the sample set is inputted from the input layer and the predicted classification label is outputted from the output layer. Generally speaking, the deep neural network includes a plurality of the learning layers. The number of the learning layers (e.g., 50-100 layers) is quite large, thereby carrying out deep learning. The deep neural network shown in FIG. 5 is only an example, and the deep neural network of the present disclosure is not limited thereto.

The deep neural network may include a plurality of convolutional layers, batch normalization layers, pooling layers, fully-connected layers, and rectified linear units (ReLu), and a Softmax output layer. The present disclosure may adopt an appropriate number of layers for the learning for compromising the prediction accuracy and the computational efficiency. It is noted that a use of too many layers may decrease the accuracy. The deep neural network may include a plurality of cascaded sub networks for improving the prediction accuracy. Each of the sub networks is connected to subsequent sub networks, for example, Dense Convolutional Network (DenseNet). The deep neural network may include residual networks for solving a degradation problem.

Step S25—adjusting the weighting parameter group by way of a backpropagation algorithm based on an error lying between the predicted classification label and an actual classification label of the sample. Optimization of the deep neural network aims at minimizing a classification loss. A backpropagation algorithm may be adopted for the optimization. That is, a predicted result obtained from the output layer is compared to an actual value to obtain an error, which is propagated backward layer by layer to calibrate parameters of each layer.

Step S26—taking out the samples of the sample set in batches (mini-batches) to train the deep neural network and fine tune the weighting parameter group to determine an optimized weighting parameter group. The weighting parameter group is fine tune a little bit every time a sub sample set (a batch) is used for the training. Such a process is iteratively performed until the classification loss converges. Finally, a parameter group carrying out the highest prediction accuracy for the test sample set is selected and serves as an optimized parameter group for the model.

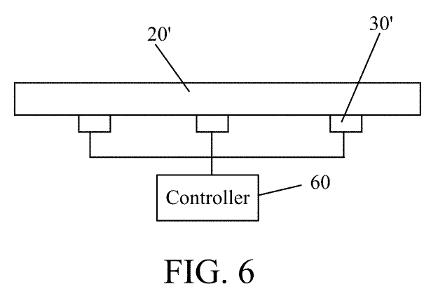

FIG. 6 is a schematic diagram illustrating a touch panel product according to an embodiment of the present disclosure. As shown in FIG. 6, the touch panel product includes a touch panel 20′, one or more vibration sensor 30′, and a controller 60. The vibration sensor 30′ can be disposed on a bottom surface of the touch panel 20′, or at any position of the touch panel product. The vibration sensor 30′ is configured to detect a vibration signal generated by a tap operation performed to the touch panel 20′. The controller 60 is coupled to the vibration sensor 30′ and receives the vibration signal generated by the vibration sensor 30′.

The controller 60 is configured to perform classification prediction for a tap event made by a user on the touch panel 20′ to obtain a predicted tap type. For example, a deep neural network identical to or corresponding to the deep neural network adopted in Steps S24 to S26 is deployed in the controller 60, and the optimized weighting parameter group obtained from Step S26 is stored in the controller 60. The corresponding deep neural network and the optimized weighting parameter group construct a prediction model. The controller 60 inputs the vibration signal from the vibration sensor 30′ into the model to obtain a corresponding classification label for the tap event. That is, the predicted tap type is obtained. In such way, the touch panel product carries out classification prediction for the tap event.

In an embodiment, the controller 60 can be any controller of the touch panel product. In another embodiment, the controller 60 may be integrated into a touch control chip. That is, the touch control chip of the touch panel product carries out not only sensing user touch operations but also predicting user tap types. Specifically, program codes corresponding to the deep neural network and the optimized weighting parameter group may be stored in firmware of the touch control chip. In executing a driver, the touch control chip can predict types of the tap events.

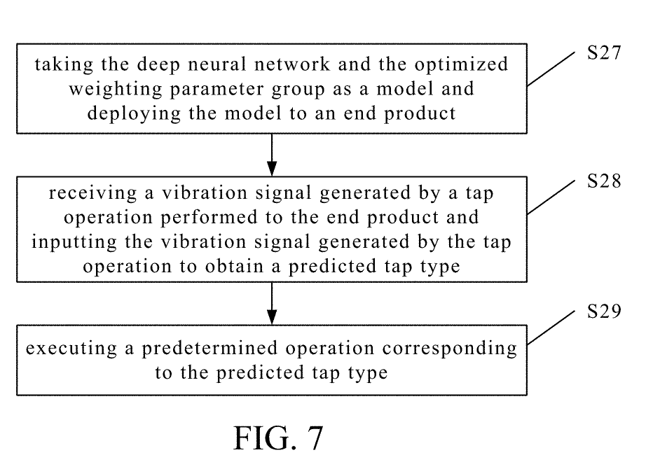

FIG. 7 is a flowchart of a method to predict the type of tap events on a touch panel according to an embodiment of the present disclosure. The method illustrated in FIG. 7 may follow the method of FIG. 2. Referring to FIG. 7 with reference to FIGS. 2 and 6, the method includes the following steps.

Step S27—taking the deep neural network and the optimized weighting parameter group as a model and deploying the model to an end product. The end product is a touch panel product, for example. In this step, the end product has a prediction model, which includes a deep neural network identical to or corresponding to the deep neural network adopted in Steps S24 to S26 and the optimized weighting parameter group obtained from Step S26.

Step S28—receiving a vibration signal generated by a tap operation performed to the end product and inputting the vibration signal generated by the tap operation to obtain a predicted tap type. In this step, when a user taps the end product, the vibration sensor 30′ of the end product obtains a measured vibration signal and inputs the vibration signal into the model to predict the type of the tap operation.

Step S29—executing a predetermined operation corresponding to the predicted tap type. In this step, the controller 60 can transmit the predicted tap type to software running in an operating system and the software can perform an operation corresponding to the predicted result.

In an exemplary application scenario, a marking software is installed on a large-sized touch display product. For instance, when a user makes a one-time tap on a surface of the product, the marking software correspondingly opens or closes a main menu. In a two-time tap, the marking software changes a brush color. In a three-time tap, the marking software changes a brush size. In another exemplary application scenario, when a user makes the one-time tap, a main menu is opened or closed. In the two-time tap, a menu item is highlighted for the user to select plural items or to select text. In another example, when playing a video or music, the one-time tap made by the user at a lateral surface of a touch pad may stop playing and the two-time tap may resume the playing.

In the present disclosure, deep learning with the deep neural network is adopted to classify various tap events on the touch panel to obtain a prediction model. The prediction model is deployed in the touch display product. Accordingly, end products can predict types of tap motions made by users to obtain predicted tap types (e.g., how many time the tap motions are made), and carry out various applications for these tap types in software applications. The present disclosure can effectively improve accuracy of predictions on tap types by use of the deep learning and greatly improve applicability.

While the preferred embodiments of the present disclosure have been illustrated and described in detail, various modifications and alterations can be made by persons skilled in this art. The embodiment of the present disclosure is therefore described in an illustrative but not restrictive sense. It is intended that the present disclosure should not be limited to the particular forms as illustrated, and that all modifications and alterations which maintain the realm of the present disclosure are within the scope as defined in the appended claims.

1. A method for classifying tap events on a touch panel, comprising:
using a vibration sensor to detect various tap events on the touch panel to obtain a plurality of measured vibration signals;
sampling each of the vibration signals and obtaining a plurality of feature values for each vibration signal;
taking the feature values of one vibration signal and a classification label recorded based on a type of the tap event corresponding to the one vibration signal as a sample and generating a sample set comprising a plurality of samples;
taking the feature values of one sample as an input and a freely-selected weighting parameter group as an adjusting parameter and inputting them into a deep neural network to obtain a predicted classification label;
adjusting the weighting parameter group by way of a backpropagation algorithm based on an error lying between the predicted classification label and an actual classification label of the sample; and
taking out the samples of the sample set in batches to train the deep neural network and fine tune the weighting parameter group to determine an optimized weighting parameter group.

2. The method according to claim 1, further comprising:
taking the deep neural network and the optimized weighting parameter group as a model and deploying the model to an end product; and
receiving a vibration signal generated by a tap operation performed to the end product and inputting the vibration signal generated by the tap operation to obtain a predicted tap type.

3. The method according to claim 2, wherein after the step of obtaining the predicted tap type, the method further comprises:
executing a predetermined operation corresponding to the predicted tap type.

4. The method according to claim 3, wherein the predetermined operation is selected from a group consisting of opening or closing a menu, changing a brush color, and changing a brush size.

5. The method according to claim 1, wherein before the step of sampling each of the vibration signals, the method further comprises:
converting each of the vibration signals from time distribution to frequency space.

6. The method according to claim 5, wherein after the step of converting to the frequency space, the method further comprises:
filtering each of the vibration signals to remove portions of high frequencies and low frequencies.

7. The method according to claim 1, wherein the deep neural network comprises a plurality of convolutional neural layers.

8. The method according to claim 1, wherein a type of the tap events is selected from a group consisting of a one-time tap, a two-time tap, and a three-time tap.

9. A system for classifying tap events on a touch panel, comprising:
a touch panel;
a vibration sensor arranged with the touch panel, configured to detect various tap events on the touch panel to obtain a plurality of measured vibration signals;
a processor coupled to the vibration sensor, configured to receive the vibration signals transmitted from the vibration sensor; and
a memory connected to the processor, comprising a plurality of program instructions executable by the processor, the processor executing the program instructions to perform a method comprising:
sampling each of the vibration signals and obtaining a plurality of feature values for each vibration signal;
taking the feature values of one vibration signal and a classification label recorded based on a type of the tap event corresponding to the one vibration signal as a sample and generating a sample set comprising a plurality of samples;
taking the feature values of one sample as an input and a freely-selected weighting parameter group as an adjusting parameter and inputting them into a deep neural network to obtain a predicted classification label;
adjusting the weighting parameter group by way of a backpropagation algorithm based on an error lying between the predicted classification label and an actual classification label of the sample; and
taking out the samples of the sample set in batches to train the deep neural network and fine tune the weighting parameter group to determine an optimized weighting parameter group.

10. The system according to claim 9, wherein before the step of sampling each of the vibration signals, the method further comprises:
converting each of the vibration signals from time distribution to frequency space.

11. The system according to claim 10, wherein after the step of converting to the frequency space, the method further comprises:
filtering each of the vibration signals to remove portions of high frequencies and low frequencies.

12. The system according to claim 9, wherein the deep neural network comprises a plurality of convolutional neural layers.

13. The system according to claim 9, wherein a type of the tap events is selected from a group consisting of a one-time tap, a two-time tap, and a three-time tap.

14. A touch panel product, comprising:
a touch panel;
a vibration sensor arranged with the touch panel, configured to detect
a vibration signal generated by a tap operation performed to the touch panel; and
a controller coupled to the vibration sensor, wherein a deep neural network corresponding to the deep neural network according to claim 1 is deployed in the controller, and the controller is configured to take the corresponding deep neural network and the optimized weighting parameter group obtained according to claim 1 as a model and input the vibration signal from the vibration sensor into the model to obtain a predicted tap type.

15. The touch panel product according to claim 14, wherein the controller is further configured to execute a predetermined operation corresponding to the predicted tap type.

16. The touch panel product according to claim 14, wherein the predetermined operation is selected from a group consisting of opening or closing a menu, changing a brush color, and changing a brush size.
